(19) United States
(12) Patent Application Publication
(10) Pub. No.: US 2007/0209039 A1
(43) Pub. Date: Sep. 6, 2007

(54) Message queue control program and message queuing system

(75) Inventors: Hironobu Kitagawa, Kanazawa (JP); Yoshitaka Honishi, Kawasaki (JP); Hideki Kawamoto, Kanazawa (JP); Takayoshi Shitan, Kanazawa (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/477,029

(22) Filed: Jun. 28, 2006

(30) Foreign Application Priority Data
Feb. 22, 2006 (JP) 2006-044980

(51) Int. Cl. G06F 9/46

(52) U.S. Cl. 719/314

(57) ABSTRACT

When a queue start instruction is input, a message queue control program starts a process of asynchronous communication and allocates a queue on a memory. Messages received from a message transmitting side application are stored into the queue. When a message receiving side application requires, the messages are transferred. When a queue shutdown instruction is input, the message queue control program saves the non-transferred messages stored in the queue to a saving file. When a queue restart instruction is input, the message queue control program acquires the messages saved to the saving file and restores them to the original queue.

### BACKGROUND OF THE INVENTION

The present invention relates to a message queuing system that transfers messages among a plurality of applications that operate in cooperation with each other through asynchronous communication, and a message queue control program that controls the system.

In a message queuing system that transfers messages among a plurality of applications through asynchronous communication, a queue (a container that stores messages) is allocated to a nonvolatile memory area (a file or database on a hard disk, for example) to store messages magnetically when reliability of communication is regarded as important, a queue is allocated to a volatile memory area (a RAM, for example) to store messages electrically when communication speed is regarded as important, in general.

Although the former method has a reliability advantage, it has a disadvantage in processing speed because a message must be read from a file or written to a file every time when the message is transmitted/received. On the other hand, the latter method has a processing speed advantage due to electrical reading/writing on the memory, however, a system failure vanishes messages and when an operator want to shut down the queue, he or she must wait until all the messages in the queue have been transmitted to avoid vanishment of the messages.

Japanese unexamined patent publication No. 2003-256255 discloses the method that records a writing action to a queue and a reading action from a queue into a log file without backing up message contents in normal operation and records a position of the read message into the file as log position information for recovery in order to recover messages based on a log file in a short time after a communication failure or a system failure. When the messages are recovered, the queue file is recovered by reflecting the log information after the log position information for recovery to a remade empty queue file.

However, the processing speed of the method in the publication is higher than the case where a queue is allocated on a nonvolatile memory area, but is lower than the case where a queue is allocated on a volatile memory area because the log file must be updated every time when a message is transmitted or received.

### SUMMARY OF THE INVENTION

It is therefore an object of the present invention to provide an improved message queuing system, which is capable of increasing a processing speed by allocating a queue on a volatile memory area and of shutting down a queue in any time without waiting time and without vanishing the queue, but which does not take measures against vanishment of messages due to unintentional failure such as a system failure. The present invention further aims to provide a message queue control program that runs on the message queuing system.

For the above object, according to the present invention, there is provided a message queue control program to control a message queuing system that transfers messages among a plurality of applications that operate in cooperation with each other through asynchronous communication, which includes:

a step for storing messages received from a transmitting side application into a volatile queue in order;

a step for transferring the messages stored in the volatile queue to a required receiving side application;

a step for saving the messages stored in the volatile queue to a nonvolatile memory area when a queue shutdown instruction is input; and

a step for shutting down the message queuing system after the messages have been saved.

In the specification, a “volatile queue” means a queue that is allocated to a memory area where stored contents volatilize and vanish at shutdown of the message queuing system. For example, it means a queue allocated to a memory of the message queuing system. Further, a “nonvolatile memory area” means a memory area where stored contents do not volatilize and are maintained at shutdown of the message queuing system. It is a concept that includes not only a disk device such as a hard disk device of the message queuing system, but also a disk device or a memory external to the message queuing system.

Further, the message queue control program of the present invention preferably includes a step for restoring the messages that were saved to the nonvolatile memory area to the volatile queue when a queue restart instruction is input after the message queuing system has been shut down.

Still further, the message queue control program of the present invention includes a step for saving messages stored in a queue to the nonvolatile memory area only when the queue is volatile at the time of input of the queue shutdown instruction, when the program includes a step for determining whether the queue to which the messages are stored is volatile or nonvolatile.

In the above-described case, it is preferable that the program includes a step for restoring the messages that were saved to the nonvolatile memory area to the queue when it is volatile at the time of input of a queue restart instruction after the message queuing system has been shut down.

On the other hand, a message queuing system of the present invention, which transfers messages among a plurality of applications that operate in cooperation with each other through asynchronous communication, includes:

storing received messages into a volatile queue in a normal operation;

saving the messages stored in the volatile queue to a nonvolatile memory area when a queue shutdown instruction is input; and

restoring the messages that were saved to the nonvolatile memory area to the volatile queue when a queue restart instruction is input after the message queuing system has been shut down.

According to the program and system of the present invention, since the message queue is allocated to the volatile memory area such as a memory, the processing speed of message transfer can increase. And since the messages are saved to the nonvolatile memory area at shutdown of the queue, the messages stored in the queue can be maintained when the queuing system shuts down. Therefore, an operator can shut down the message queuing system immediately at any timing without vanishing the message contents, which allows an operator to perform maintenance and to alter configuration settings in timely fashion. As a result, a recovery time from a trouble can be shortened, for example.

Further, even if an operator unintentionally shuts down the message queuing system due to a misoperation, the messages can be maintained. And then, the operator can continue the operation after the queuing system restarts, under the condition where the messages that were saved to the nonvolatile memory area are restored to the volatile queue when a queue restart instruction is input after the message queuing system has been shut down.

### DESCRIPTION OF THE ACCOMPANYING DRAWINGS

FIG. 1 is a block diagram showing one example of a network system that uses a message queuing system according to an embodiment of the present invention;

FIG. 2 is a flowchart showing processing contents of the message queue control program of the embodiment from a start to a finish;

FIG. 3 is a flowchart showing processing contents of the message queue control program of the embodiment during a restart after a finish; and

FIG. 4 is a timing chart showing timings of instruction transfer and message transfer in the network system of the embodiment.

### DESCRIPTION OF THE PREFERRED EMBODIMENTS

Hereinafter, an embodiment of a message queuing system and a message queue control program will be described with reference to the drawings.

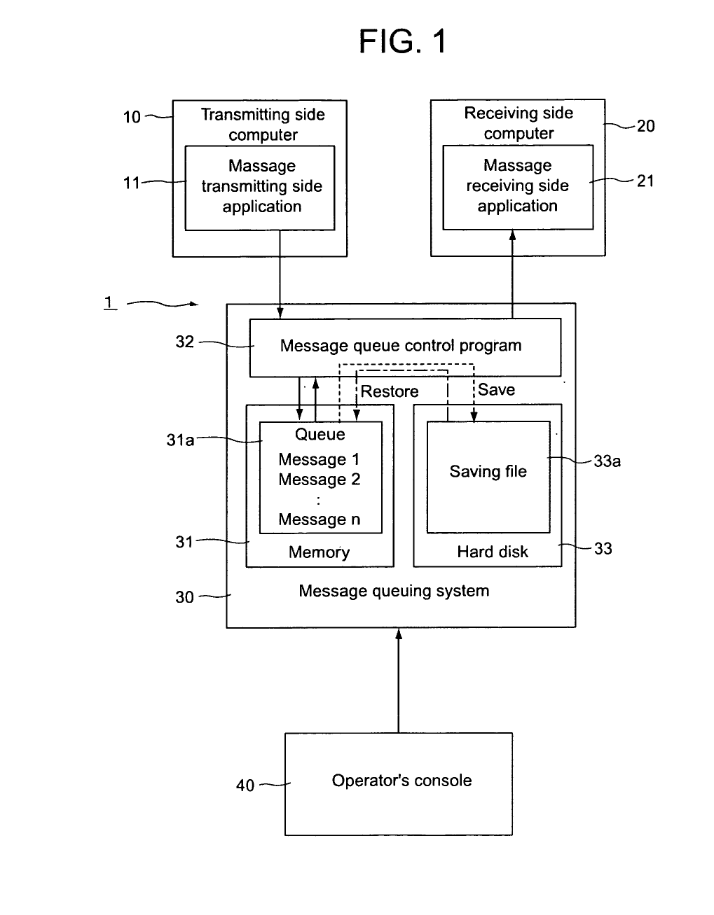

First, a general outline of a network system to which the queuing system of the embodiment is applied will be described based on FIG. 1. As shown in FIG. 1, the network system 1 includes a transmitting side computer 10 on which a message transmitting side application 11 is executed, a receiving side computer 20 on which a message receiving side application 21 is executed, a message queuing system 30 that controls asynchronous communication of messages among these applications, and an operator's console 40 that is operated by an operator to give instructions to the message queuing system 30.

The message queuing system 30 is provided with a memory 31 as a volatile memory area, a message queue control program 32 that controls the system, and a hard disk 33 as a nonvolatile memory area. A queue 31a, which is a container to store messages, is allocated to the memory 31 and messages received from the transmitting side application 11 are stored in the queue 31a. In this example, the message 1, the message 2, . . . , the message n are stored. Further, the hard disk 33 includes a saving file 33a to which messages in the queue are saved at the system shutdown.

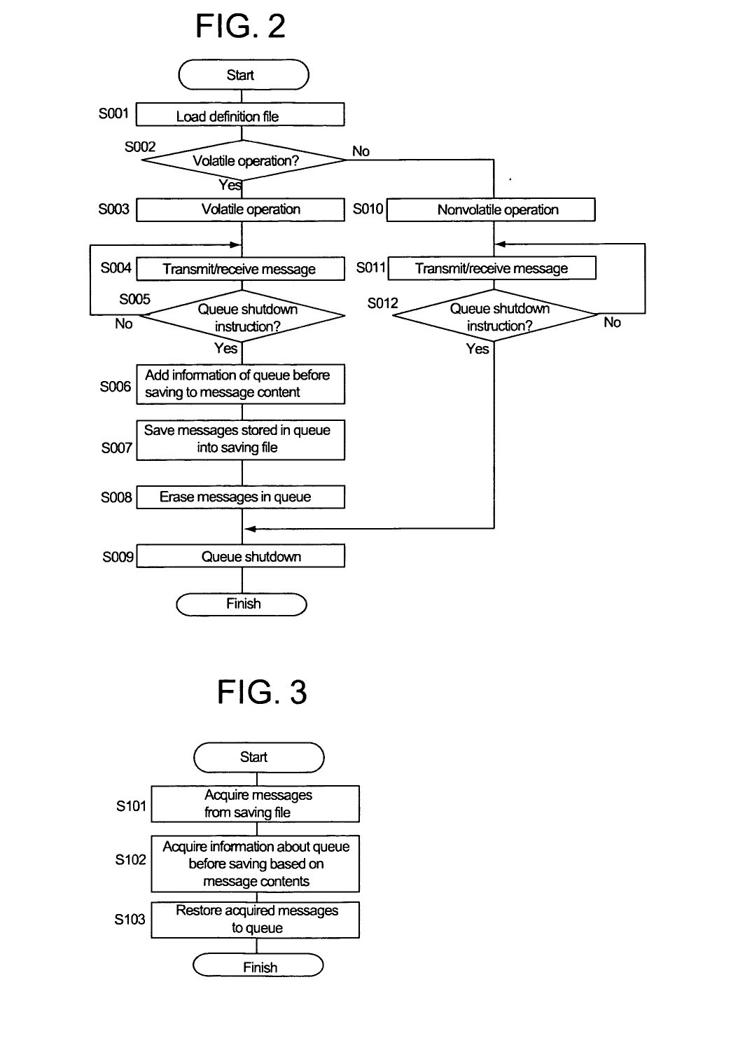

Next, the process contents of the message queue control program 32 will be described based on a flowchart shown in FIG. 2.

When a queue start instruction is input from the operator's console 40, the message queue control program 32 starts asynchronous communication process. At first, the message queue control program 32 loads a predetermined definition file (S001). The definition file defines whether the message queue of the asynchronous communication operates on the volatile memory area or on the nonvolatile memory area.

Next, the message queue control program 32 determines whether the queue operates on the volatile memory area or not based on the definition in the definition file (S002) When the queue operates on the volatile memory area (S002: Yes), a volatile operation is performed (S003). That is, the queue 31a is allocated on the memory 31 of the message queuing system 30. Then, when the program receives a message from the message transmitting side application 11, it stores the message into the queue 31a and when the program is required from the message receiving side application 21, it transfers the message (S004). In the volatile operation, since the messages are electrically stored in the memory 31, the processing speed can increase.

The above-described transmitting/receiving process is repeatedly executed until a queue shutdown instruction is input (S005: No). When the queue shutdown instruction is input from the operator's console 40 (S005: Yes), the message queue control program 32 adds the information of the queue 31a before the saving to the message content (S006) and saves it together with the non-transferred messages that are stored in the queue into the saving file 33a (S007). After the saving process is completed, the program erases the messages in the queue (S008), shuts down the message queuing system 30 (S009), and finishes the process. As described above, in the volatile operation, since the messages stored in the queue are saved in the saving file when the operator instructs shutdown of the queue, it is possible to shut down the message queuing system 30 immediately without waiting the transfer of the messages to the receiving side application 21. Accordingly, the high speed processing during operation can be compatible with the reduction of the waiting time at the time of shutdown.

On the other hand, when the queue operates oh the nonvolatile memory area (S002: No), a nonvolatile operation is performed (S010). That is, for example, in the configuration of FIG. 1, the queue is allocated on the hard disk 33 of the message queuing system 30. When the program receives a message from the message transmitting side application 11, it stores the message into the queue and when the program is required from the message receiving side application 21, it transfers the message (S011). In the nonvolatile operation, since the messages are stored into or read from the hard disk, the processing speed decreases, while the messages can be maintained at an unintentional system failure. That is, it can avoid vanishment of the messages.

The above-described transmitting/receiving process is repeatedly executed until a queue shutdown instruction is input (S012: No). When the queue shutdown instruction is input from the operator's console 40 (S012: Yes), the message queue control program 32 shuts down the message queuing system 30 (S009) and finishes the process. As described above, in the nonvolatile operation, since the messages are stored in the nonvolatile memory area, the save of the messages is unnecessary even when the operator shuts down the queue, he or she can shuts down the system as-is.

When a queue restart instruction is input from the operator's console 40, the program executes a restoring process shown in FIG. 3 and then returns to the process of FIG. 2. In the restoring process in FIG. 3, the message queue control program 32 acquires the saved messages from the saving file 33a (S101), acquires the information of the saved queue before the saving from the contents of the messages (S102), restores the acquired messages to the saved queue (S103), and finishes the process. As a result, the message queue control program 32 can continue the process under the same condition as that before the shutdown.

In the meantime, S002 in the flowchart in FIG. 2 corresponds to a step where the message queue control program 32 determines whether the queue to which the messages are stored is volatile or nonvolatile, S004 corresponds to a step for storing messages received from the transmitting side application into a volatile queue in order and a step for transferring the message stored in the volatile queue to a required receiving side application, S007 corresponds to a step for saving the messages stored in the volatile queue to a nonvolatile memory area when a queue shutdown instruction is input, S009 corresponds to a step for shutting down the message queuing system after the messages have been saved, S101 through S103 in the flowchart in FIG. 3 correspond to a step for restoring the messages that were saved to the nonvolatile memory area to the volatile queue.

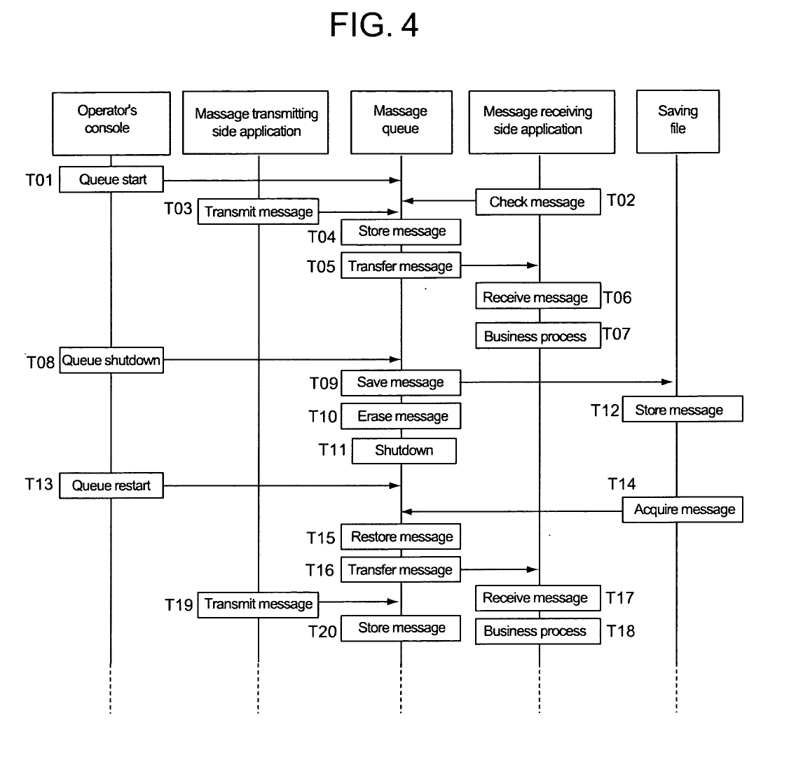

Next, the flows of the messages and instructions in the volatile operation according to the above-described message queue control program 32 will be described based on a timing chart shown in FIG. 4. The communications of the instructions and messages among the operator's console 40, the message transmitting side application 11, the message queue 31a, the message receiving side application 21, and saving file 33a will be described here. In addition, the functions of the message queue control program 32 are also illustrated as the functions of the message queue 31a in FIG. 4 for the sake of simplicity. For example, although the instruction from the operator's console 40 is passed to the message queue control program 32 in actual fact, it is illustrated to be passed to the message queue 31a in FIG. 4.

When the queue start instruction in the volatile operation is input from the operator's console 40 (T01), a message can be transmitted to or received from the message queue through the message queue control program 32. The message receiving side application 21 checks whether a message has been input to the message queue or not (T02) and waits until it is input. If the message is transmitted from the message transmitting side application 11 (T03), the message is stored in the message queue (T04) and is transferred in response to the degree of processing of the message receiving side application 21 (T05). The message receiving side application 21 receives the message (T06) and performs a business process according to the message (T07).

The process from T02 to T07 is repeatedly executed until a queue shutdown instruction is input. The message transmitting side application 11 transmits the messages in order and then the messages are stored in the message queue 31a. The message receiving side application 21 receives the next message after it finishes the business process based on the current message in accordance with its own processing speed. In this way, the involvement by the message queue allows both of the applications to operate in cooperation with each other through asynchronous communication. When the queue shutdown instruction is input from the operator's console 40 (T08), the message queue control program 32 saves the non-transferred messages to the saving file 33a (T09) if any non-transferred messages remain in the message queue 31a, then, the program erases the non-transferred messages (T10), and the system shuts down (T11). The messages are stored in the saving file 33a (T12).

When the queue restart instruction is input from the operator's console 40 (T13), the message queue control program 32 acquires the saved messages from the saving file 33a, restores the acquired messages to the queue (T14, T15), and transfers them to the message receiving side application 21 (T16). The message receiving side application 21 receives the message (T17) and performs the business process based on the message (T18). When a message is transmitted from the message transmitting side application 11 (T19), the message is stored in the message queue (T20). The messages are transferred to the message receiving side application 21 and are processed in order in the same manner as described above.

As described above, the message queuing system 30 and the message queue control program 32 according to the embodiment can increase the processing speed in the volatile operation because the queue 31a is allocated on the memory 31. Further, the system 30 and program 32 can immediately shut down the system in any timing without vanishing the non-transferred messages because the messages are saved to the saving file 33a at shutdown of the queue. This allows an operator to perform maintenance and to alter configuration settings in timely fashion.

In addition, although the non-transferred messages saved to the hard disk 33 of the message queuing system in the embodiment, they may be saved to a disk or a memory an external computer.

What is claimed is:

1. A message queue control program to control a message queuing system that transfers messages among a plurality of applications that operate in cooperation with each other through asynchronous communication, said program comprising:
a step for storing messages received from a transmitting side application into a volatile queue in order;
a step for transferring said messages stored in said volatile queue to a required receiving side application;
a step for saving messages stored in said volatile queue to a nonvolatile memory area when a queue shutdown instruction is input; and
a step for shutting down said message queuing system after said messages have been saved.

2. The message queue control program according to claim 1, further comprising:
a step for restoring said messages that were saved to said nonvolatile memory area to said volatile queue when a queue restart instruction is input after said message queuing system has been shut down.

3. A message queue control program to control a message queuing system that transfers messages among a plurality of applications that operate in cooperation with each other through asynchronous communication, said program comprising:
a step for determining whether a queue to which messages are stored is volatile or nonvolatile;
a step for storing messages received from a transmitting side application into said queue in order;
a step for transferring said messages stored in said queue to a required receiving side application;
a step for saving messages stored in said queue to a nonvolatile memory area only when said queue is volatile at the time of input of a queue shutdown instruction; and
a step for shutting down said message queuing system after said messages have been saved when said queue is volatile or after said queue shutdown instruction is input when said queue is nonvolatile.

4. The message queue control program according to claim 3, further comprising:
a step for restoring the messages that were saved to said nonvolatile memory area to said queue when it is volatile at the time of input of a queue restart instruction after said message queuing system has been shut down.

5. A message queuing system that transfers messages among a plurality of applications that operate in cooperation with each other through asynchronous communication, said system comprising:
storing received messages into a volatile queue in a normal operation;
saving said messages stored in said volatile queue to a nonvolatile memory area when a queue shutdown instruction is input; and
restoring the messages that were saved to said nonvolatile memory area to said volatile queue when a queue restart instruction is input after said message queuing system has been shut down.
